(19) United States
(12) Patent Application Publication
(10) Pub. No.: US 2025/0384240 A1
(43) Pub. Date: Dec. 18, 2025

(54) SYSTEMS AND METHODS FOR PARALLEL FINETUNING OF NEURAL NETWORKS

(71) Applicant: Salesforce, Inc., San Francisco, CA (US)

(72) Inventors: Shiva Kumar Pentyala, Mountain View, CA (US); Bin Bi, Bellevue, WA (US); Regunathan Radhakrishnan, San Francisco, CA (US); Sitaram Asur, Newark, CA (US); Na (Claire) Cheng, Yarrow Point, WA (US)

(21) Appl. No.: 18/742,628

(22) Filed: Jun. 13, 2024

(51) Int. Cl. G06N 3/045

(52) U.S. Cl. CPC G06N 3/045

(57) ABSTRACT

Embodiments described herein provide a parallel adapter-based training paradigm that trains multiple adapters in parallel for specific tasks or domains. The trained adapters are then selectively merged with a base neural network to produce a new finetuned neural network that is finetuned to perform the specific tasks. In this way, the parallel training largely improves computational efficiency to train or adapt a neural network for different tasks without repeated retraining of the entire neural network.

### CROSS-REFERENCE

The instant application is related to commonly-owned and co-pending U.S. application Ser. No. ______ (attorney docket no. 70689.341US01) and ______ (attorney docket no. 70689.341US02), filed on the same day, which are hereby explicitly incorporated by reference herein in their entirety.

### TECHNICAL FIELD

The embodiments relate generally to neural networks and machine learning systems, and more specifically to parallel finetuning of neural networks such as large language models (LLMs).

### BACKGROUND

Neural networks such as Large Language Models (LLMs) are often trained on vast amounts of training data to perform various language tasks, such as question and answering, summarization, paraphrasing, machine translation, and/or the like. Traditionally, LLMs are trained sequentially on different datasets so as to be adapted to different tasks or domains one after the other. For example, an LLM may be finetuned using a dataset of legal documents to understand legal writing, and then may be finetuned using a data set of mathematical problems and answers to write solutions to mathematical problems.

Such sequential finetuning can be both inefficient and limiting. On one hand, finetuning an LLM to multiple tasks or multiple domains sequentially involves repeated computationally expensive training iterations. On another, sequential fine-tuning risks erasing value knowledge and patterns that the LLM learns from previous training datasets when the LLM is being updated on new training datasets.

Therefore, there is a need to improve the training paradigm of neural networks across different tasks and domains.

### BRIEF DESCRIPTION OF THE DRAWINGS

FIG. 1A is a simplified diagram illustrating an example sequential finetuning paradigm of a neural network, according to embodiments described herein.

FIG. 1B is a simplified diagram illustrating an example parallel finetuning paradigm by finetuning multiple adapter neural networks on multiple training datasets in parallel, according to embodiments described herein.

FIG. 1C is a simplified diagram illustrating an example parallel finetuning paradigm by finetuning multiple adapter neural networks using different training methods in parallel, according to embodiments described herein.

FIGS. 2A-2B are simplified diagrams illustrating example architectures of merging one or more finetuned adapter neural networks to a neural network model, according to embodiments described herein.

FIG. 3 is a simplified diagram illustrating a computing device implementing the parallel training paradigm of neural networks through merging described in FIGS. 1B-2B, according to one embodiment described herein.

FIG. 4 is a simplified diagram illustrating the neural network structure implementing the neural network parallel adaptation module described in FIG. 3, according to some embodiments.

FIG. 5 is a simplified block diagram of a networked system suitable for implementing the neural network parallel adaptation described in FIGS. 1B-2B and other embodiments described herein.

FIG. 6 is an example logic flow diagram illustrating an example method of parallel training a neural network to perform multiple tasks, according to embodiments described herein.

FIG. 7 is an example data performance chart comparing performance metrics of the parallel training paradigm with the traditional sequential training paradigm, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

To train or adapt a neural network such as an LLM to perform a specific task or on a specific domain, e.g., to understand and generate a legal document, to understand and answer mathematical questions, and/or the like, the LLM may be finetuned using a training dataset for the specific task. Traditionally, LLMs are trained sequentially on different datasets so as to be adapted to different tasks or domains one after the other. Such sequential finetuning can be both inefficient and limiting. On one hand, finetuning an LLM to multiple tasks or multiple domains sequentially involves repeated computationally expensive training iterations. On another, sequential fine-tuning risks erasing value knowledge and patterns that the LLM learns from previous training datasets when the LLM is being updated on new training datasets. In addition, sequential fine-tuning may also hinder the LLM from developing highly specialized adaptations for each distinct task or algorithms, as the later fine-tuning iterations may always overwrite earlier fine-tuning.

In view of the need to improve the training paradigm of neural networks across different tasks and domains, embodiments described herein provide a parallel adapter-based training paradigm that trains multiple adapters in parallel for specific tasks or domains. The trained adapters are then selectively merged with a base neural network to produce a new finetuned neural network that is finetuned to perform the specific tasks. In this way, the parallel training largely improves computational efficiency to train or adapt a neural network for different tasks without repeated retraining of the entire neural network.

For example, instead of training and retraining the entire LLM using a training dataset for the specific tasks or domain, an adapter neural network may be used. An adapter neural network is usually a smaller neural network module compared to an LLM, that is added to the original LLM and trained to perform specific tasks. During training, instead of updating the weights and/or parameters of the entire LLM, only the weights of the adapter neural networks are updated while keeping the bulk of the original LLM unchanged. This approach helps reduce the computational cost and memory footprint associated with finetuning LLMs for specific tasks or on a specific domain.

In one embodiment, multiple adapter neural networks may be trained in parallel, each being trained on a respective training dataset for a specific task or a domain. For example, separate adapter neural networks may be trained in parallel, each specializing in a specific dataset or algorithm. This preserves the knowledge acquired during each distinct specialization process. For another example, the trained adapters may be merged into a single, enhanced LLM. The merging process can be customized based on the expert weightage for the use case, e.g., reasoning capabilities may be needed while JSON following may be less weighed.

In this way, by training separate adapters in parallel, sequential overwriting of knowledge is avoided. Hence the resulting LLM may retain the knowledge learned from each specialization through the specific training dataset of specific task or domain. The trained separate adapters have the freedom to ‘hyper-focus’ on their target task or algorithm, leading to more refined domain-specific adaptations. In addition, parallel training reduces the need for repeated retraining of the entire neural network. With enhanced computational efficiency, neural network technology is thus improved.

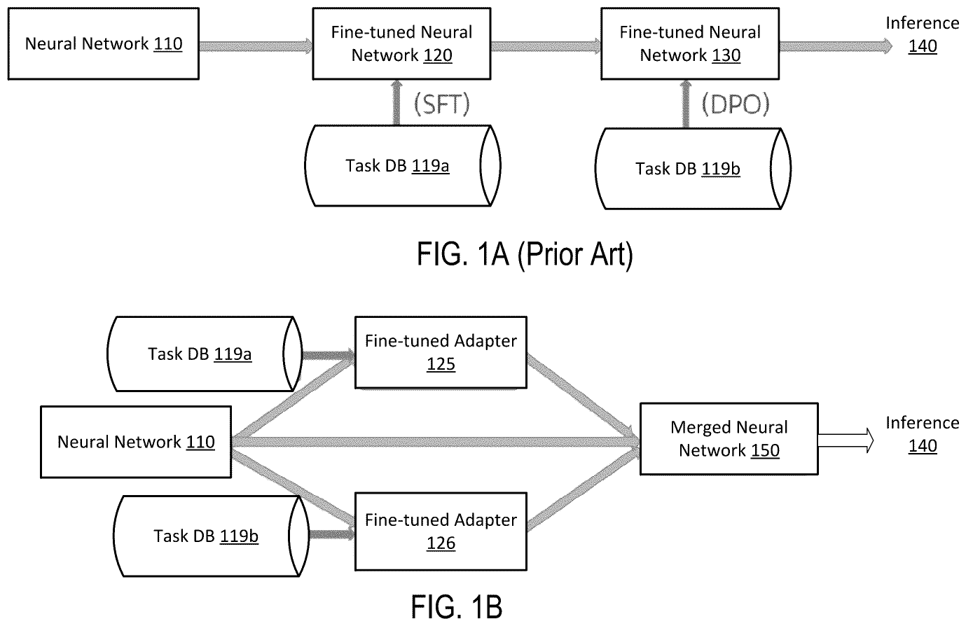

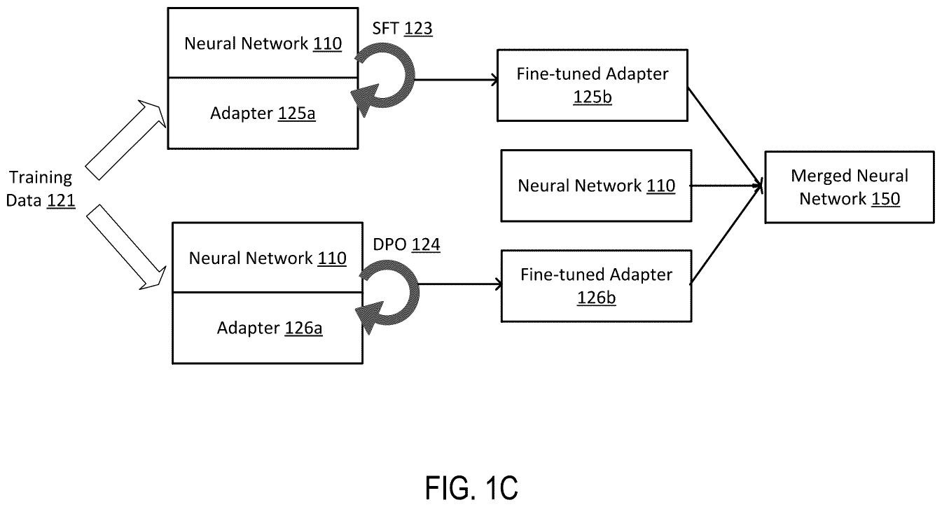

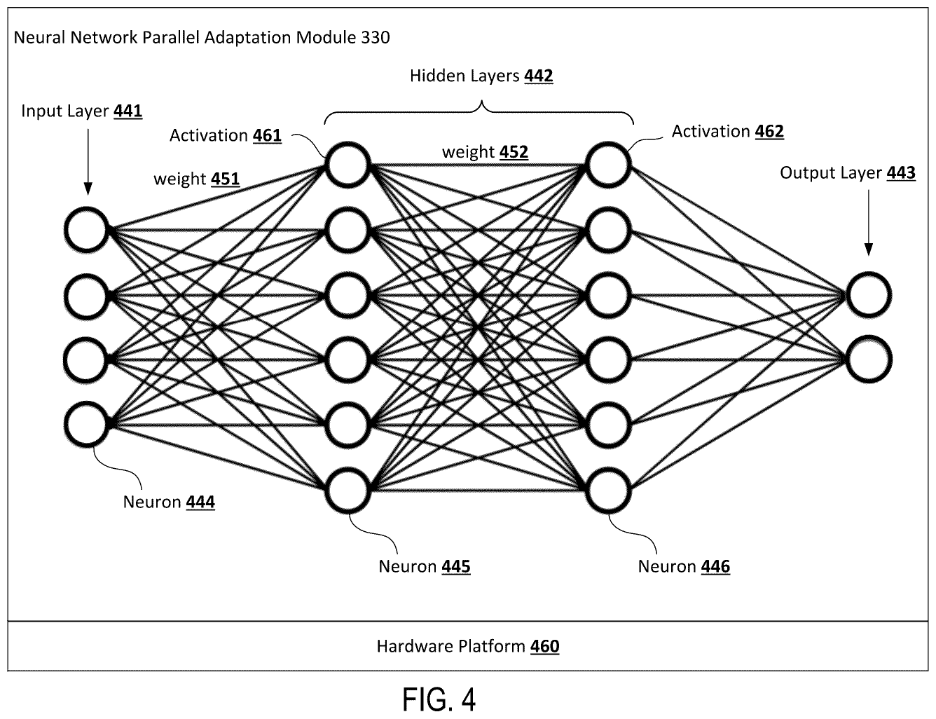

FIG. 1A is a simplified diagram illustrating an example sequential finetuning paradigm of a neural network, according to embodiments described herein. As shown in FIG. 1A, traditionally, a neural network 110 may be sequentially finetuned on different datasets so as to be adapted to different tasks or domains one after the other. For example, neural network 110 may be finetuned using a dataset 119a for a first specific task, such as understanding and generating legal documents. The fine-tuning may be performed using annotated legal documents under supervised finetuning (SFT) to result in a fine-tuned neural network 120. Additional details of training/finetuning a neural network may be described in relation to FIG. 4.

The fine-tuned neural network 120 may then be finetuned again using a training dataset 119b of mathematical problems and answers to write solutions to mathematical problems. The fine-tuning may be performed using annotated legal documents under direct preference optimization (DPO) to result in a fine-tuned neural network 130. The resulting fine-tuned neural network 130 may then be used at inference 140 for generating legal documents, and/or solving an input mathematical problem. However, as discussed above, from the sequential learning paradigm, knowledge learnt to generate legal documents by the neural network 120 may be diluted in later finetuning.

FIG. 1B is a simplified diagram illustrating an example parallel finetuning paradigm by finetuning multiple adapter neural networks on multiple training datasets in parallel, according to embodiments described herein. As shown in FIG. 1B, instead of sequentially finetuning the neural network 110 using different training datasets one after another, separate adapter neural networks are trained in parallel.

For example, an adapter neural network 125 may be trained in conjunction with the neural network 110 using a training dataset 119a for a first specific task, such as understanding and generating legal documents. In parallel, an adapter neural network 126 may be trained in conjunction with a copy of the neural network 110 using a training dataset 119b for a second specific task, such as understanding and writing solutions to mathematical problems.

In one implementation, for example, to adapt neural network 110 with pretrained weights for a specific task, such as to generate and understand a legal document, or to understand and provide a solution to a mathematical problem, and/or the like, adapter neural network 125 or 126 may be used to learn the task-specific and/or domain-specific features. During training, a training input from the training dataset 119a or 119b may be fed to the combined neural network of the neural network 110 and the adapter 125 or 126, which in turn generates a training output. For example, the training input may comprise a mathematical problem,

$${lim}_{n \to ∞} {( 1 + \frac{1}{n} )}^{n} = ?$$

And the combined model may generate a predicted training output, which may be used to compute a loss. The parameters of the neural network 110 are kept fixed (frozen) during backpropagation based on the loss. In other words, the gradients from the loss function are not propagated through the parameters of the neural network 110 during backpropagation. In one embodiment, the training process may involve joint optimization of the adapter parameters of adapter 125 or 126 and the parameters of the neural network 110. But only parameters of the adapter neural network 125 or 126 are updated during backpropagation to result in the fine-tuned adapter neural networks 125 and 126.

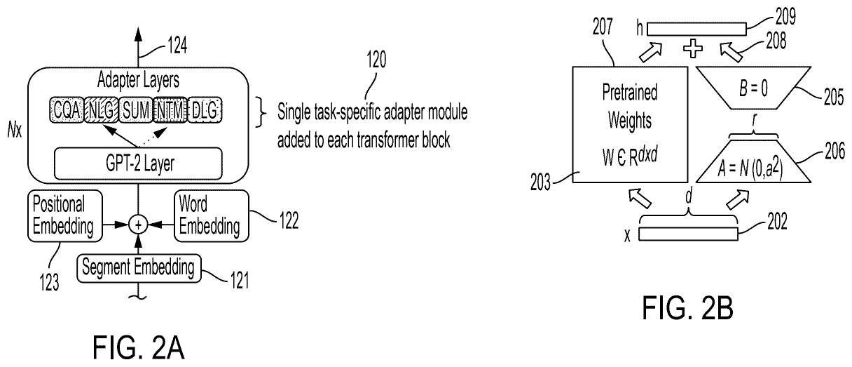

The fine-tuned adapter neural networks 125 and 126 may be merged into the layers of the neural network 110 to result in the merged neural network 150. Additional examples of merging the adapter neural networks 125 or 126 to the neural network 110 may be illustrated in FIGS. 2A-2B.

FIG. 1C is a simplified diagram illustrating an example parallel finetuning paradigm by finetuning multiple adapter neural networks using different training methods in parallel, according to embodiments described herein. As shown in FIG. 1C, adapter 125a or 126a may be trained in conjunction with neural network 110 using training data 121, which may be drawn from the same or different training datasets 119a-b as shown in FIG. 1B. Specifically, adapter neural network 125a may be trained in conjunction with neural network 110 under supervised finetuning (SFT) 123, e.g., via backpropagation based on a training loss computed based on a training output as described in relation to FIG. 1B.

Adapter neural network 126a may be trained in conjunction with neural network 110 using a different training method, such as DPO 124. For example, adapter neural network 126a and neural network 110 may jointly generate a training output in response to training input data 121, and the adapter neural network 126a may then be updated based on direct feedback from users. DPO may directly incorporate human preferences or feedback into the optimization process.

For example, user may directly provide feedback or preferences towards training outputs, such ratings, rankings, pairwise comparisons, or explicit preferences. Such feedback may be used to update parameters of the adapter neural network 126a while freezing neural network 110.

While training processes of adapters 125a, 126a may be performed in parallel, the resulting fine-tuned adapters 125b and 126b may be merged with neural network 110 to result in the merged neural network 150.

In some embodiments, the multiple trained adapter networks may be selectively merged depending on a customized application request. For example, a trained adapter may not be merged into the final neural network 150 if the specific task that the trained adapter corresponds to is deemed no longer needed. For another example, the multiple trained adapters may be merged with weights, as discussed below in relation to FIGS. 2A-2B.

In one embodiment, adapter neural networks 125 and 126 may be trained in conjunction with the same target neural network 110 in parallel. In another embodiment, adapter neural networks 125 and 126 may be trained in conjunction with the same of different neural networks that are compatible with the target neural network 110. For example, one or more neural networks may be chosen from a library having a tree structure of neural networks, in which next-level neural networks are obtained by merging one or more neural networks from a previous level. Thus, adapter neural networks 125 and 126 may be trained in parallel with an ancestor neural network to the neural network 110. Additional details of such adapter training may be found in commonly-owned and co-pending U.S. application Ser. No. ______ (attorney docket no. 70689.341US01), filed on the same day, which is hereby explicitly incorporated by reference herein in its entirety.

FIGS. 2A-2B are simplified diagrams illustrating example architectures of merging one or more finetuned adapter neural networks to a neural network model, according to embodiments described herein. As shown in FIG. 2A, when the base model (e.g., neural network 110 in FIGS. 1A-1C) has a Transformer architecture, a single task-specific adapter module 125 or 126 may be added to each transformer block. For example, the adapter 125 or 126 may receive segment embedding 121, positional embedding 123, word embedding 122 from other layers in a Transformer block, and in turn generate an adapter output 124. During training, the gradients from a training loss are propagated through the added adapter layers 125 or 126 in every Transformer block.

Similarly, when more than one adapter modules are merged into a Transformer block, the finetuned adapter neural networks such as 125 and 126 may be stacked, placed in parallel and/or arranged in other manner in the Transformer block. For example, weight matrices of multiple adapters are usually merged into the Transformer block matrix of the same shape so the size of the merged model does not increase (e.g., number of weights in base model=number of weights in the new model after merging adapters). An example merging may be performed as follows: if base model has weight matrix of shape [2048, 4096] in layer L, and given adapters will also have same shape of [2048, 4096], by doing weight average across three matrices, resulting matrix would be [2048, 4096] as well.

In another example, FIG. 2B illustrates a Low Rank Adapter (LoRA) that is added to a pretrained base model 110 (such as a Transformer model) through low-rank parameterization. For example, given the pre-trained weight matrix 203 of base model 110: W with a dimension of d×d, the adapter weight change matrix ΔW of an adapter neural network 125 or 126 may be decomposed into two low-rank projection matrices A 206 and B 205. The two low-rank projection matrices A 206 and B 205 each be initialized as a normal distribution A=N (0, σ²) and B=0, and then updated during training.

When a new training input x 202 enters the combined model of base model 110 and the adapter 125 or 126, x will be multiplied with W 203 and ΔW (A and B) separately. So the dimension of x multiplying with W becomes 1×d, and the dimension of x multiplying with ΔW is also 1×d. The two output vectors 207 and 208 from the multiplication are summed coordinate-wise to become the final output h 209 so that h=W₀x+ΔW x=W⁰x+BAx. Matrices A and B are in turn updated during backpropagation while the W 203 is frozen during training.

Similarly, when more than one LORA modules are merged, the finetuned adapter neural networks such as 125 and 126 may be represented as matrices A₁, B₁, and A₂, B₂ such that the output h=W₀x+ΔW₁ x+ΔW₂ x=W⁰x+B₁A₁x+B₂A₂x. In one embodiment, a weight factor α may be applied to the adapters so as to prioritize or deprioritize a specific finetuned adapter: W⁰x+B₁A₁x+αB₂A₂x. For example, the parameter a may indicate whether the resulting neural network 150 may place more emphasis on adapter ΔW₂ or ΔW₁, e.g., reasoning capabilities may be more heavily weighed while JSON following may be less weighed.

For example, when a chatbot is built for different languages, and on day 0 an English dataset is created and used to finetune adapter1 in conjunction with base model W0; on day 1, a French dataset is created and used to finetune adapter 2 in conjunction with base model W0. Based on user traffic in specific region for deploying the chatbot, the weight for each adapter may be defined, e.g., in European region the weight may be higher for the “French” adapter, in US region he can have higher weight for English. In this way, different versions of Chatbot may be created by merging the base model and adapters based on the weights. The merging significantly saves the compute and development effort for building new models. For example, whenever a new language support is desired for the chatbot, no retraining of the whole model using an entire dataset of the new language is needed. Finetuning a model for new tasks can be made much faster and computationally efficient. Also, finetuning the adapter only eliminates the need for version control of prior training datasets, e.g., previous datasets and their versions may no longer be stored for retraining.

### Computer and Network Environment

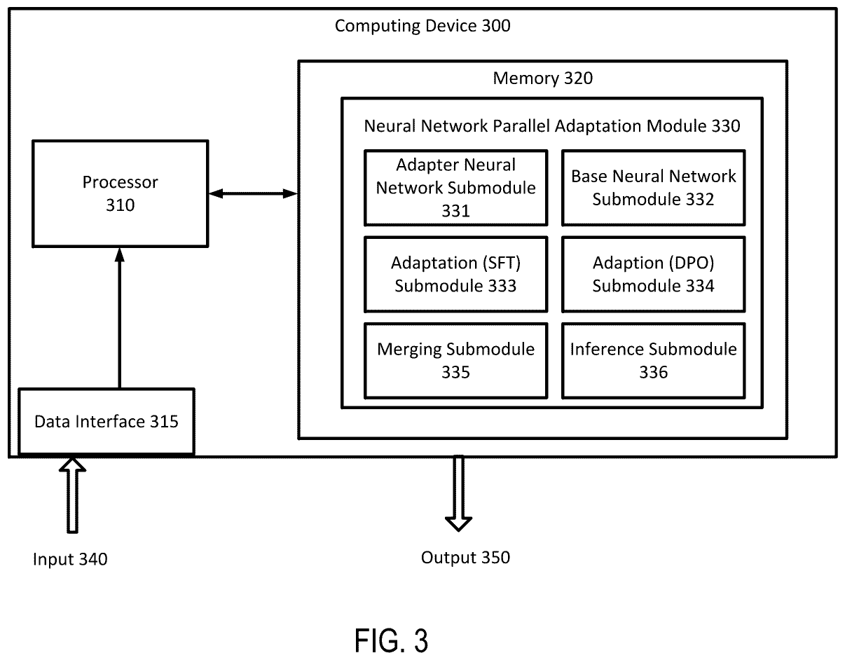

FIG. 3 is a simplified diagram illustrating a computing device implementing the parallel training paradigm of neural networks through merging described in FIGS. 1B-2B, according to one embodiment described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for neural network parallel adaptation module 330 that may be used to implement and/or emulate the systems and models, and/or to implement any of the methods described further herein. Neural network parallel adaptation module 330 may receive input 340 such as an input text via the data interface 315 and generate an output 350 which may be a natural language processing task output.

The data interface 315 may comprise a communication interface, a user interface (such as a voice input interface, a graphical user interface, and/or the like). For example, the computing device 300 may receive the input 340 (such as a training text input) from a networked database via a communication interface. Or the computing device 300 may receive the input 340, such as a user utterance, from a user via the user interface.

In some embodiments, the neural network parallel adaptation module 330 is configured to adapt a base neural network model such as an LLM to perform a specific task. The neural network parallel adaptation module 330 may further include an adapter neural network submodule 331 (e.g., 125, 126 in FIGS. 1B-1C), a base neural network submodule 332 (e.g., 110 in FIGS. 1B-1C), adaptation submodules 333-334 (e.g., for performing parallel training process in FIGS. 1B-1C), a merging submodule 335 (e.g., for performing the merging process as shown in FIGS. 2A-2B), and an inference submodule 336 (e.g., for using the merged neural network at inference).

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4 is a simplified diagram illustrating the neural network structure implementing the neural network parallel adaptation module described in FIG. 3, according to some embodiments. In some embodiments, the neural network parallel adaptation module 330 and/or one or more of its submodules 331-336 may be implemented at least partially via an artificial neural network structure shown in FIG. 3. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 340 in FIG. 3), such as an input image and an input text. The number of nodes (neurons) in the input layer 441 may be determined by the dimensionality of the input data (e.g., the length of a vector of a latent feature of the input image). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the neural network parallel adaptation module 530 receives an input 440 of an input image and transforms the input into an output 450 of an image representation. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the neural network parallel adaptation module 530 and/or one or more of its submodules 331-336 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer model, and/or the like.

In one embodiment, the neural network parallel adaptation module 330 and its submodules 331-336 may be implemented by hardware, software and/or a combination thereof. For example, the neural network parallel adaptation module 330 and its submodules 331-336 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based neural network parallel adaptation module 330 and one or more of its submodules 331-336 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as a training image or a training text are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as image animation.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in applications of intelligent agents.

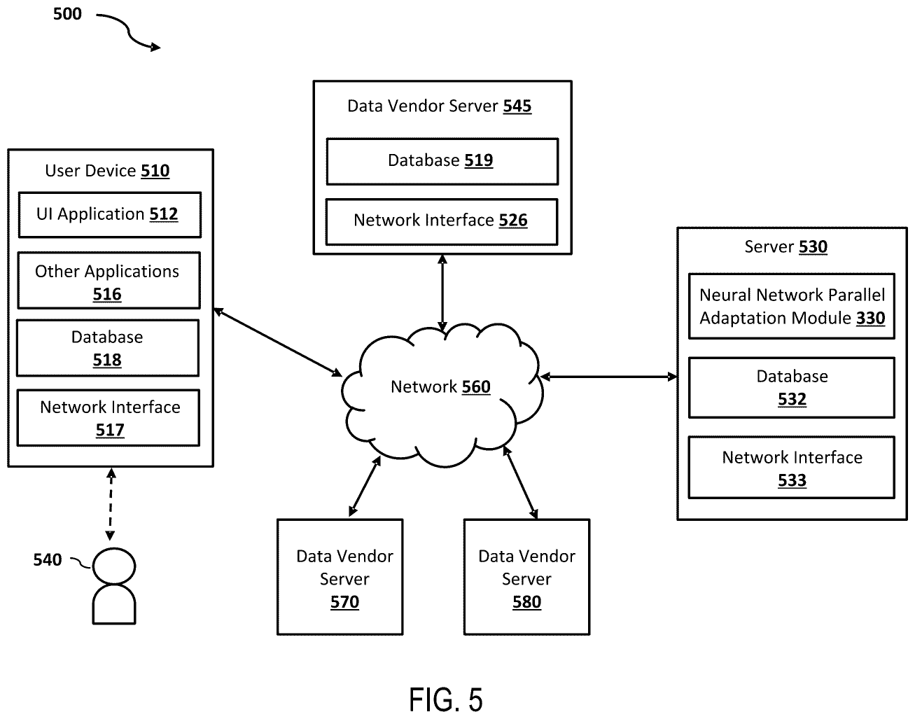

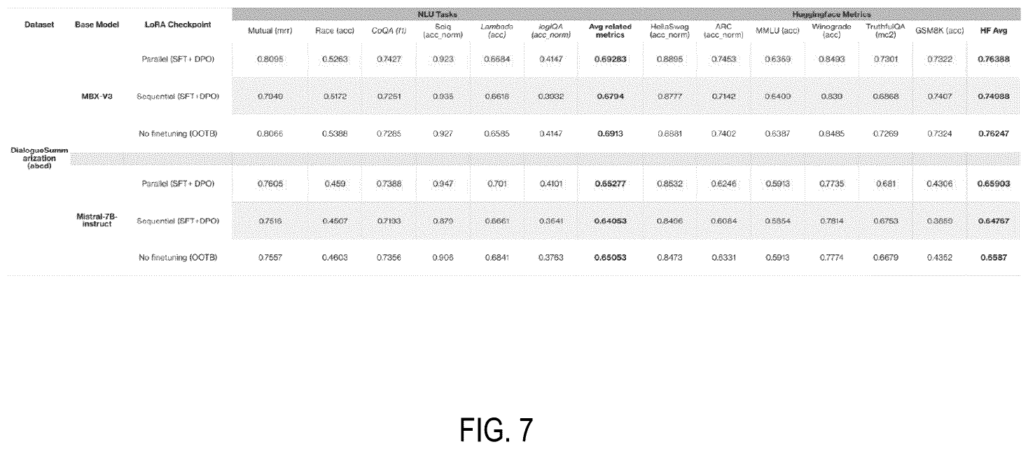

FIG. 5 is a simplified block diagram of a networked system suitable for implementing the neural network construction through merging described in FIGS. 1-6 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 700 described in FIG. 7, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive generated LLM outputs.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560. For example, each data vendor servers may provide domain specific training datasets to server 530.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating an LLM output from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a forecast result from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the visualized output.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including training images/texts to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the neural network parallel adaptation module 330 and its submodules described in FIG. 3. In some implementations, neural network parallel adaptation module 330 may receive domain-specific or task-specific training data from database 519 at the data vendor server 545 via the network 560 for training (e.g., process 100 in FIG. 1). At inference, the generated output may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the neural network parallel adaptation module 530. In one implementation, the database 532 may store previously generated tensor vectors, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flow

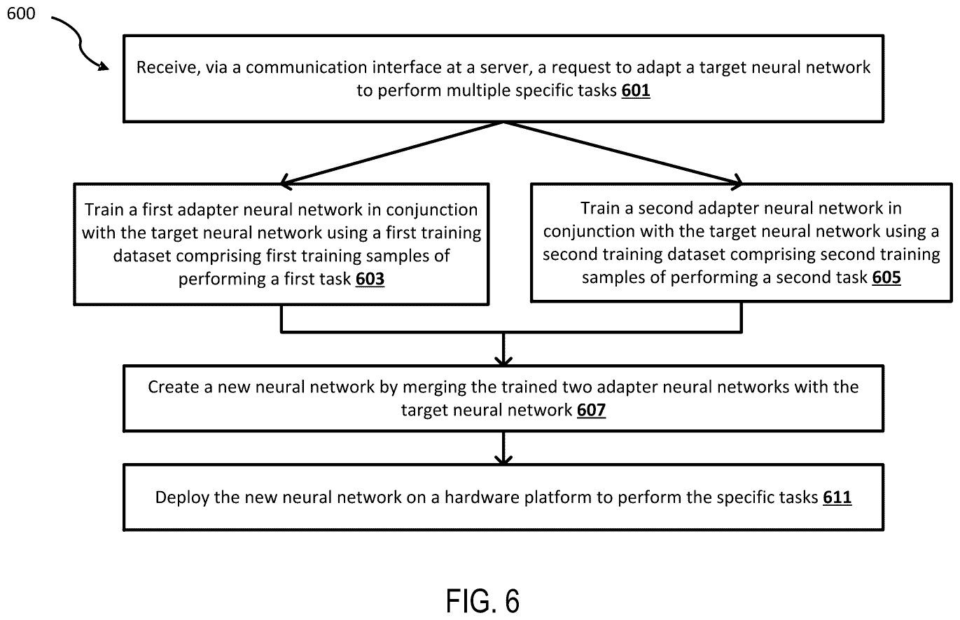

FIG. 6 is an example logic flow diagram illustrating an example method of parallel training a neural network to perform multiple tasks, according to embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the neural network parallel adaptation module 330 (e.g., FIGS. 3 and 5).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a communication interface (e.g., 315 in FIG. 3, 533 in FIG. 5) at a server (e.g., 930 in FIG. 9) may receive a request to adapt a target neural network to perform multiple specific tasks.

At steps 603 and 605, a first adapter neural network (e.g., 125 in FIG. 1B) may be trained in conjunction with the neural network (e.g., 110 in FIG. 1B) using a first training dataset (e.g., 119a in FIG. 1B) comprising first training samples of performing a first task, and in parallel, a second adapter neural network (e.g., 126 in FIG. 1B) may be trained in conjunction with a copy of the neural network (e.g., 110 in FIG. 1B) using a second training dataset (e.g., 119b in FIG. 1B) comprising second training samples of performing a second task. For example, each of steps 603 and 605 may further comprise jointly generating, by a combination of the first (or second) adapter neural network and the neural network, a training output based on a training input from the first or (second) training dataset, and updating weights of the first (or second) adapter neural network based on a training loss computed from the training output while keeping weights of the neural network unchanged.

In one implementation, the first training dataset and the second training dataset are from different domains.

In one implementation, the first adapter neural network and the second adapter neural network are trained using different training methods such as SFT or DPO.

At step 607, the trained first adapter neural network, the trained second adapter neural network and the neural network may be merged to produce an adapted neural network (e.g., 150 in FIG. 1B). In one implementation, the trained multiple adapter neural networks may be selectively merged depending on an application request. For example, one or more of the first and second adapter neural networks may be merged into the neural network. For another example, the trained first and second adapter neural networks may be merged with a respective weights.

At step 611, the new neural network may be deployed for inference to generate a first task output or a second task output in response to an input to perform the first task or the second task.

FIG. 7 is an example data performance chart comparing performance metrics of the parallel training paradigm with the traditional sequential training paradigm, according to embodiments described herein. Example data experiments results are shown for experiment scenario of algorithm-wise parallel training for domain specific finetuning use case of dialogue summarization. As shown in FIG. 7, finetuning on a domain is prone to cause regression on other tasks. To measure this, dialogue summarization is finetuned. It is observed that sequential training paradigm boosts domain specific metrics but regresses significantly on other tasks. Parallel SFT and DPO paradigm significantly outperforms.

In particular, it is observed that SFT and DPO exhibit different properties when tested on domain specific finetuning use case specifically with dialogue summarization task. For example, SFT paradigm tend to match the response style (JSON, custom formatting etc.) while DPO paradigm helps learn reasoning. Thus the parallel SFT and DPO paradigm alleviates the risk of one overwriting the other.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of parallel training a neural network to perform multiple tasks, the method comprising:
training in parallel:
a first adapter neural network in conjunction with the neural network using a first training dataset comprising first training samples of performing a first task, and
a second adapter neural network in conjunction with a copy of the neural network using a second training dataset comprising second training samples of performing a second task;
merging the trained first adapter neural network, the trained second adapter neural network and the neural network to produce an adapted neural network; and
generating, by the adapted neural network, a first task output or a second task output in response to an input to perform the first task or the second task.

2. The method of claim 1, wherein training the first adapter neural network comprises:
jointly generating, by a combination of the first adapter neural network and the neural network, a training output based on a training input from the first training dataset; and
updating weights of the first adapter neural network based on a training loss computed from the training output while keeping weights of the neural network unchanged.

3. The method of claim 1, wherein the first training dataset and the second training dataset are from different domains.

4. The method of claim 1, wherein the first adapter neural network and the second adapter neural network are trained using different training methods.

5. The method of claim 4, wherein the first adapter neural network is trained using supervised finetuning, and the second adapter neural network is trained using direct preference optimization.

6. The method of claim 1, further comprising:
training in parallel multiple adapter neural networks in conjunction with the neural network using multiple training datasets for multiple tasks or domains; and
selectively merging one or more of the trained multiple adapter neural networks with the neural network depending on an application request.

7. The method of claim 1, wherein the merging comprises merging a first set of layers of the trained first adapter neural network, a second set of layers of the trained second adapter neural network, and a third set of layers of the neural based on a per-layer basis.

8. The method of claim 1, wherein the first adapter neural network and the second adapter neural network are trained in conjunction with a different neural network, wherein the different neural network is compatible with the neural network.

9. A system of parallel training a neural network to perform multiple tasks, the system comprising:
a communication interface;
a memory storing a plurality of processor-executable instructions; and
one or more processors executing the plurality of processor-executable instructions to perform operations comprising:
training in parallel:
a first adapter neural network in conjunction with the neural network using a first training dataset comprising first training samples of performing a first task, and
a second adapter neural network in conjunction with a copy of the neural network using a second training dataset comprising second training samples of performing a second task;
merging the trained first adapter neural network, the trained second adapter neural network and the neural network to produce an adapted neural network; and
generating, by the adapted neural network, a first task output or a second task output in response to an input to perform the first task or the second task.

10. The system of claim 9, wherein the operation of training the first adapter neural network comprises:
jointly generating, by a combination of the first adapter neural network and the neural network, a training output based on a training input from the first training dataset; and
updating weights of the first adapter neural network based on a training loss computed from the training output while keeping weights of the neural network unchanged.

11. The system of claim 9, wherein the first training dataset and the second training dataset are from different domains.

12. The system of claim 9, wherein the first adapter neural network and the second adapter neural network are trained using different training systems.

13. The system of claim 12, wherein the first adapter neural network is trained using supervised finetuning, and the second adapter neural network is trained using direct preference optimization.

14. The system of claim 9, wherein the operations further comprise:
training in parallel multiple adapter neural networks in conjunction with the neural network using multiple training datasets for multiple tasks or domains; and
selectively merging one or more of the trained multiple adapter neural networks with the neural network depending on an application request.

15. The system of claim 9, wherein the operation of merging comprises merging a first set of layers of the trained first adapter neural network, a second set of layers of the trained second adapter neural network, and a third set of layers of the neural based on a per-layer basis.

16. The system of claim 9, wherein the first adapter neural network and the second adapter neural network are trained in conjunction with a different neural network, wherein the different neural network is compatible with the neural network.

17. A non-transitory processor-readable storage medium storing a plurality of processor-executable instructions for parallel training a neural network to perform multiple tasks, the instructions being executed by one or more processors to perform operations comprising:
training in parallel:
a first adapter neural network in conjunction with the neural network using a first training dataset comprising first training samples of performing a first task, and
a second adapter neural network in conjunction with a copy of the neural network using a second training dataset comprising second training samples of performing a second task;
merging the trained first adapter neural network, the trained second adapter neural network and the neural network to produce an adapted neural network; and
generating, by the adapted neural network, a first task output or a second task output in response to an input to perform the first task or the second task.

18. The non-transitory processor-readable storage medium of claim 17, wherein the first training dataset and the second training dataset are from different domains.

19. The non-transitory processor-readable storage medium of claim 17, wherein the first adapter neural network and the second adapter neural network are trained using different training methods.

20. The method of claim 19, wherein the first adapter neural network is trained using supervised finetuning and the second adapter neural network is trained using direct preference optimization.
